(19) United States
(12) Patent Application Publication
(10) Pub. No.: US 2011/0187280 A1
(43) Pub. Date: Aug. 4, 2011

(54) PRIMARY DRIVE SYNCHRONOUS HIGH-SPEED SWITCHING RECTIFYING CIRCUIT FOR LLC HALF-BRIDGE POWER CONVERTER FOR DRIVING LED

(75) Inventor: IL HWI CHUNG, Seoul (KR)

(73) Assignee: AVERD LABS CO., LTD., Goyang-si (KR)

(21) Appl. No.: 12/696,255

(22) Filed: Jan. 29, 2010

(51) Int. Cl. H05B 41/36

(52) U.S. Cl. 315/291

(57) ABSTRACT

Disclosed herein is a secondary rectifier for an LLC half-bridge power converter for driving an LED, which provides a power converter with efficiency and stability higher than a conventional power converter using a rectifying diode. The LLC half-bridge power converter does not employ a fast recovery diode or a Schottky diode for secondary rectification and uses FETs as rectifying elements to achieve high efficiency, high stability and low cost and small volume.

### BACKGROUND OF THE INVENTION

1. Field of the Invention

The present invention relates an LLC (Inductor, Inductor and Capacitor) half-bridge power converter for driving an LED, and more particularly, to a primary drive synchronous high-speed switching rectifying circuit for an LLC half-bridge power converter for driving an LED, which uses a field effect transistor (FET) instead of a general fast recovery (FR) diode or a Schottky diode as a secondary rectifier to achieve high efficiency, stability, low cost and small volume.

2. Background of the Related Art

Current power converters for driving LED lamps do not meet high efficiency and low energy consumption because specifications of LEDs are unsettled and the power converters do not satisfy required conditions. This is caused by problems of LEDs and, particularly, short lifetime and high error rate of the power converters. Considering this circumstance, a problem calling for immediate solution is to secure high efficiency and high stability of power converters.

Currently most widely used typical PWM power converters include flyback, forward and half-bridge power converters, and LLC half-bridge power converters that have been recently commercially used as power converters for driving LED lamps.

The power converters for driving LEDs rapidly switch input power according to PWM control to generate AC signals, stabilize the AC signals to appropriate levels, rectify the stabilized signals through a secondary rectifier and output the rectified signals to a load. The secondary rectification largely affects the efficiency of the power converters.

The most widely used rectifying method utilizes a high-speed rectifier. In a conventional rectifying method, Vf×A=loss Watt. Here, Vf represents a forward voltage drop (Vf) of a rectifier.

FIG. 1 is a circuit diagram of a conventional flyback power converter with a secondary rectifier.

Referring to FIG. 1, input power Vin is rapidly switched through a switch 1 and output as an AC signal through a transformer 2 to a secondary side of the transformer 2. The AC signal is switched and rectified by a switching rectifier control IC 3-1 of a rectifier 3, smoothened through a smoothing condenser C₀ and output to a load 4.

FIG. 2 is a circuit diagram of a conventional forward power converter with a secondary rectifier.

Referring to FIG. 2, input power V_{IN} is rapidly switched by switching transistors Q1 and Q2 of a switching unit 1′ and output as an AC signal through a transformer 2′ to a secondary side of the transformer 2′. The AC signal is rectified by a forward secondary rectifier 3′ at the secondary side and output to a load.

The flyback power converter shown in FIG. 1 and the forward power converter shown in FIG. 2 are well known in the art so that detailed explanations thereof are omitted. However, the flyback power converter and the forward power converter use PWM method instead of full ware method as a driving method and do not have 50% duty cycle. That is, the power converters have off time. Accordingly, the efficiency of the flyback and forward power converters is lower than the efficiency of the LLC half-bridge power converter operating at 50% duty cycle.

FIG. 3 is a circuit diagram of a conventional LLC half-bridge power converter.

Referring to FIG. 3, the conventional LLC half-bridge power converter includes a controller 50 that generates a predetermined frequency signal to control output of DC power, a power output unit 10 that receives the frequency signal of the controller 50 through a primary coil of a first transformer T1 and switches the DC power through two switching transistors FET1 and FET2 controlled by outputs of two secondary coils of the first transformer T1 to generate AC pulse signals, an LLC resonator 20 that resonates the AC pulse signals of the power output unit 10 through an inductor L1, a primary coil of a second transformer T2 and a resonating condenser C1, a rectifier 30 that rectifies an output voltage applied across both terminals of a secondary coil of the second transformer T2 according to diodes D4 and D5, smoothens the rectified voltage through a smoothing condenser C4 and outputs a DC voltage +12V for driving a load, and an output level feedback unit 40 that divides the output of the rectifier through voltage-dividing resistors R4 and R5, detects the output level of the rectifier 30 through a level detecting element TSR and feeds back the output of the level detecting element TSR to the controller 50 through an opto-coupler PC1.

In the aforementioned conventional LLC half-bridge power converter, when the primary coil of the first transformer T1 is controlled according to frequency control of the controller 50, voltages are respectively induced to the two secondary coils of the first transformer T1 according to the DC power, and thus the two switching transistors FET1 and FET2 respectively generate pulse signals. These pulse signals are resonated by the LLC resonator 20 and rectified by the rectifier 30 to output DC power for driving the load. The operation of the conventional LLC half-bridge power converter is well-known in the art so that detailed explanation thereof is omitted.

Most conventional power converters use PWM method that generates off time. Conventional power converters using the PWM method may increase the off time while reducing Vf loss of a secondary rectifier and do not generate a threshold problem.

However, the LLC half-bridge power converter does not have satisfactory delay time, rise time and fall time due to characteristics of FETs at the primary side when the FETs are turned on/off because the LLC half-bridge power converter uses full wave frequency variation (50 KHz to 1 MHz). Further, the LLC half-bridge power converter has recovery time of the secondary rectifier and the threshold problem.

Meanwhile, heat radiation is the most difficult part in the design of a power converter. In the power converter, the secondary rectifier brings about heating. Particularly, excessive heat increases the volume of the power converter and requires an expensive heat sink or additional fan. If heat is excessively emitted from the power converter and exceeds an allowance value, the power converter, a part of a device using the power converter or the device is fatally damaged.

This problem must be solved in order to achieve a high-efficiency, small-volume and high-stability inexpensive power converter capable of reducing Vf loss of a secondary rectifier thereof.

### SUMMARY OF THE INVENTION

Accordingly, the present invention has been made in view of the above-mentioned problems occurring in the prior art, and it is a primary object of the present invention to provide a primary drive synchronous high-speed switching rectifier circuit for an LLC half-bridge power converter for solving threshold problem caused by a delay time increased when a frequency is transited to a high level by using response time that is the property of an operational amplifier.

The high-speed switching rectifier circuit generates pulse off time using response characteristic of an operational amplifier and turns on/off a rectifier configured of an FET according to the pulse off time to solve the threshold problem and restrains heating to thereby provide a high-speed high-efficiency power converter.

To accomplish the above object of the present invention, according to the present invention, there is provided an LLC half-bridge power converter for driving an LED, which is configured to receive a 50% duty cycle pulse signal according to frequency control of a controller, generate a pulse signal through an output unit, resonate the pulse signal through an LLC resonator, rectify the resonated signal through a second rectifier and output DC power. FETs are used as rectifying elements of the secondary rectifier. The LLC half-bridge power converter for driving an LED further includes a rectifier controller configured to delay an input pulse by delay time set in consideration of element delay, rise time and fall time and generate a control pulse signal having off time between pulses according to alternate combination of a delayed pulse and the input pulse to control the FETs of the secondary rectifier.

The rectifier controller includes an input pulse detector receiving the 50% duty cycle pulse signal through a primary coil and detecting the pulse signal through secondary coils in phase with the first transformer T1; a delay unit comparing the pulse signal detected by the input pulse detector with a reference signal of a delay time setting unit and delaying rise time and fall time of the pulse signal; a rectifier control pulse generator performing an AND operation on a pulse delayed by the delay unit and negative and positive pulses detected by the input pulse detector to generate a rectifier control pulse signal having off time between pulses; and a rectifier on/off time controller performing an AND operation on a first rectifier pulse input to a fourth rectifying FET of the secondary rectifier and a second rectifier pulse input to a third rectifying FET of the secondary rectifier, buffering the AND operation resultant signals and alternately applying the buffered signals as gate control signals of the third and fourth rectifying FETs to control on/off time of the rectifier pulse signal generated by the rectifier control pulse generator.

The LLC half-bridge power converter for driving an LED has the threshold problem generated in the secondary rectifier due to delay in a primary element and delay in rise time and fall time because the LLC half-bridge power converter uses full wave frequency variation. To solve the threshold problem, the present invention uses an FET as a rectifying element and generates a rectifier control pulse signal having off time to control the FET. Accordingly, a high-speed high-efficiency synchronous switching rectifier circuit can be provided.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a circuit diagram of a conventional flyback power converter with a secondary rectifier;

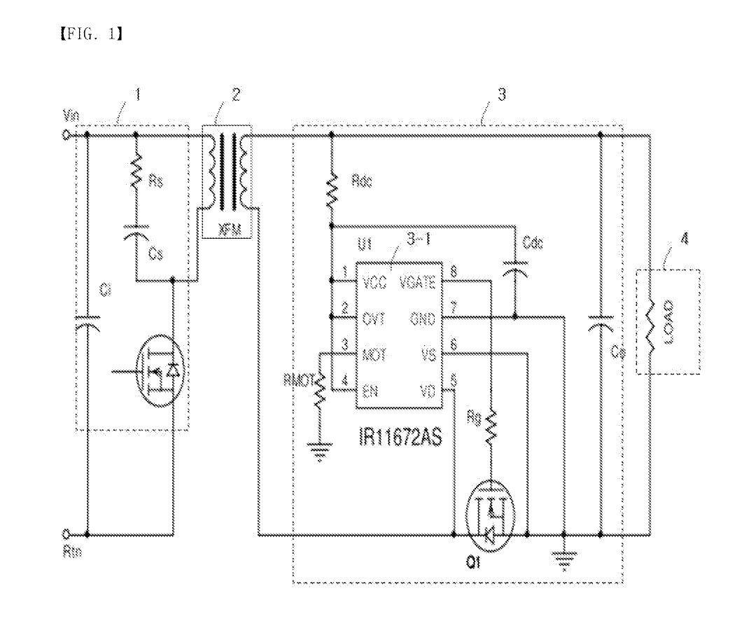

FIG. 2 is a circuit diagram of a conventional forward power converter with a secondary rectifier;

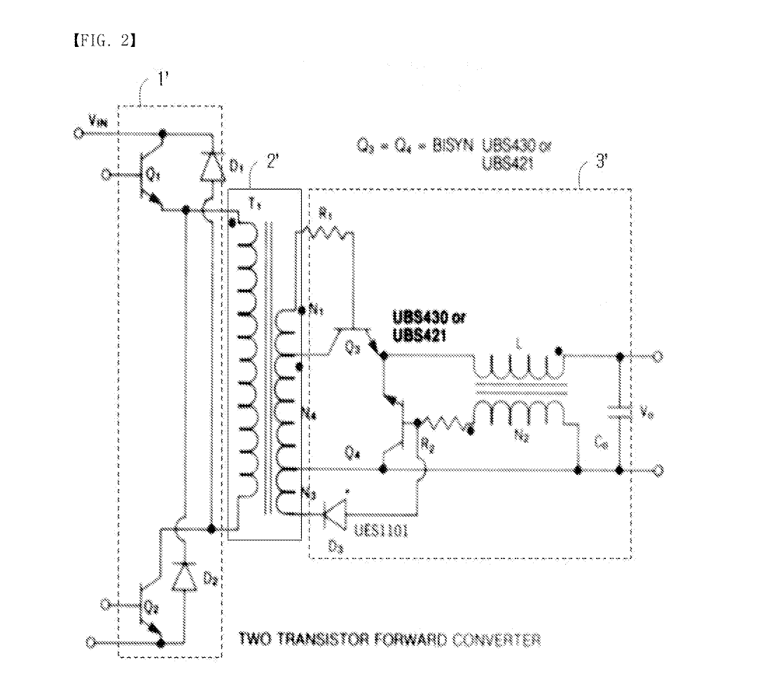

FIG. 3 is a circuit diagram of a conventional LLC half-bridge power converter;

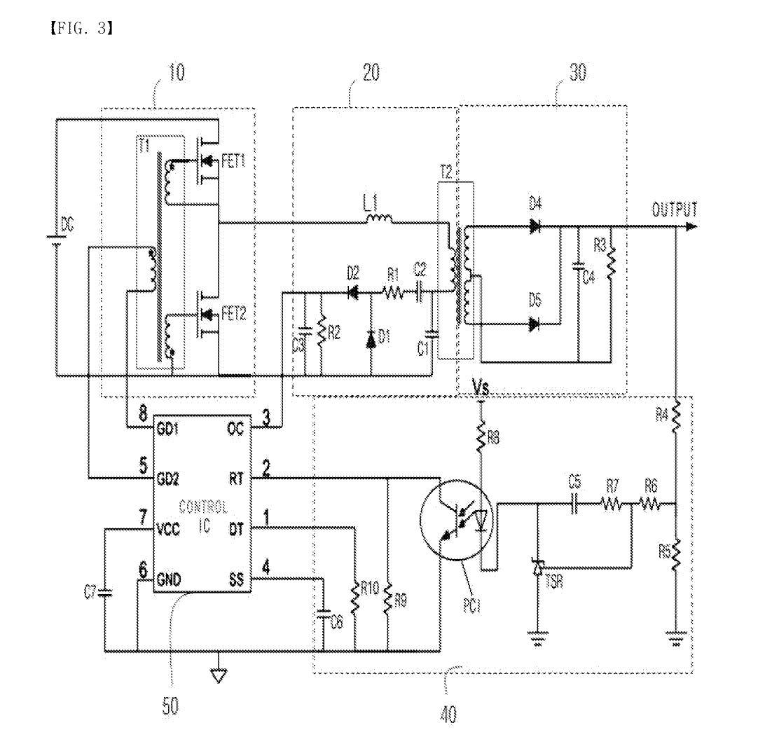

FIG. 4 shows pulse response characteristics of an operational amplifier for explaining the present invention; and

FIG. 5 is a circuit diagram of an LLC half-bridge power converter for driving an LED, which includes a rectifier controller, according to the present invention.

### DETAILED DESCRIPTION OF THE PREFERRED EMBODIMENT

The present invention will now be described more fully with reference to the accompanying drawings, in which exemplary embodiments of the invention are shown.

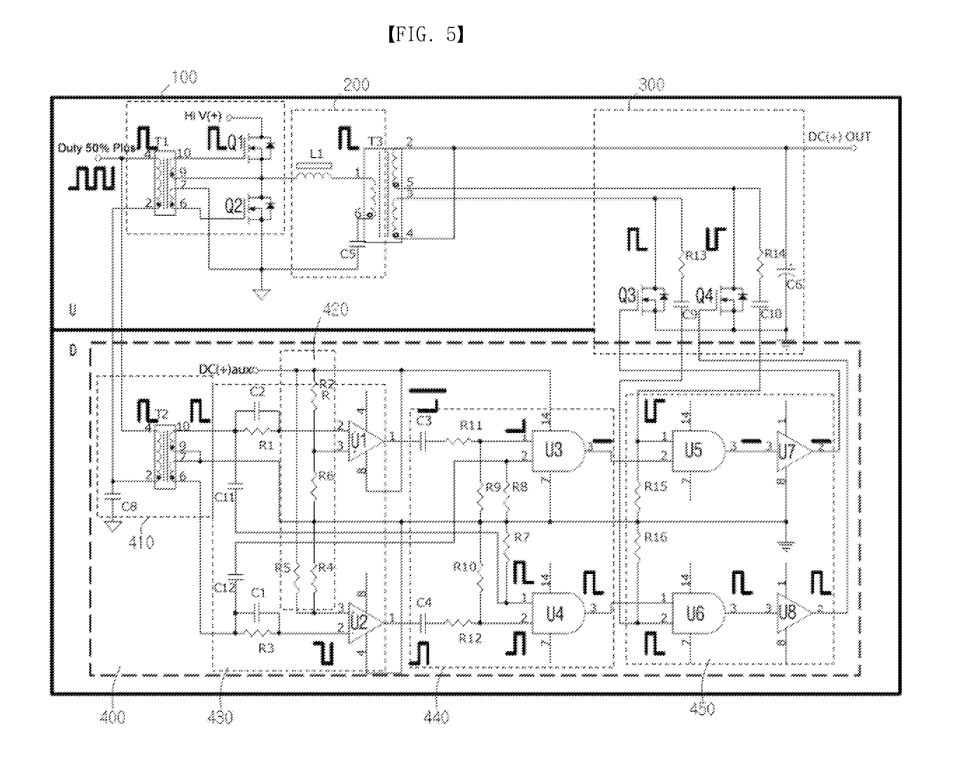

FIG. 5 is a circuit diagram of an LLC half-bridge power converter for driving an LED, which includes a rectifier controller, according to the present invention.

Referring to FIG. 5, the LLC half-bridge power converter for driving an LED includes an output unit 100 that receives a 50% duty cycle pulse signal according to frequency control of a controller (not shown) and generates pulse signals (having positive voltage periods and negative voltage periods) through a first transformer T1 and first and second switching FETs Q1 and Q2, a resonator 200 that LLC-resonates the pulse signals of the output unit 100 through an inductor L1, a primary coil of a third transformer T3 and a resonating condenser C5, and a secondary rectifier 300 that rectifies pulse signals output from two secondary coils of the third transformer T3 through rectifying elements, smoothens the rectified signals through a smoothing condenser C6 and outputs the smoothened signals to a load.

The secondary rectifier 300 uses third and fourth FETs Q3 and Q4 as the rectifying elements to full-wave-rectify the pulse signals.

The LLC half-bridge power converter further includes a rectifier controller 400 that is configured to delay input pulses by delay time set in consideration of delay in an element, rise time and fall time and generate a control pulse signal having off time between pulses according to alternate combination of the delayed pulses and the input pulses to control the third and fourth FETs Q3 and Q4 of the secondary rectifier 300.

The rectifier controller 400 includes an input pulse detector 410 that receives the 50% duty cycle pulse signal through a primary coil and detects the pulse signal through two secondary coils in phase with the first transformer T1, a delay unit 430 that compares the pulse signal detected by the input pulse detector 410 with a reference signal of a delay time setting unit 420 and delays rise time and fall time of the pulse signal; a rectifier control pulse generator 440 that alternately performs an AND operation on pulses delayed by the delay unit 430 and negative and positive pulses detected by the input pulse detector 410 to generate a rectifier control pulse signal having off time between pulses, and a rectifier on/off time controller 450 that performs an AND operation on a first rectifier pulse signal input to the fourth FET Q4 of the secondary rectifier 300 and a second rectifier pulse signal input to the third FET Q3 of the secondary rectifier 300, buffers the AND operation resultant signals and alternately applies the buffered signals as gate control signals of the third and fourth FETs Q3 and Q4 to control on/off time of the rectifier control pulse signal generated by the rectifier control pulse generator 440. Here, the controller, a feedback unit and a frequency varying unit of the controller according to the feedback unit, which are circuit components of the power converter, are not shown in FIG. 5 because the present invention relates to control of the secondary rectifier.

The LLC half-bridge power converter for driving an LED, constructed as above, has delay time, rise time and fall time according to characteristics of the first and second switching FETs Q1 and Q2 of the output unit 100 when the first and second switching FETs Q1 and Q2 are turned on/off because the LLC half-bridge power converter uses full wave frequency variation.

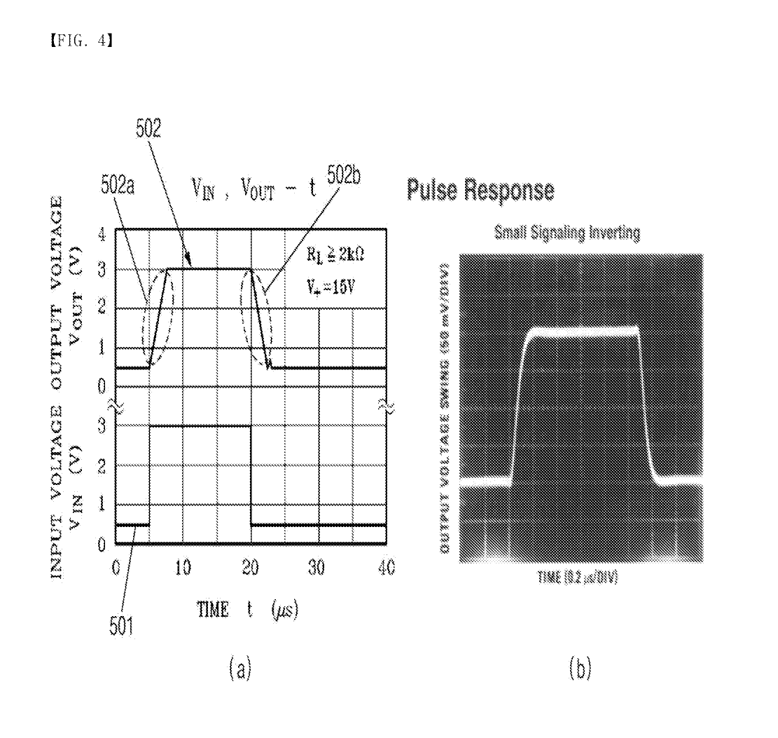

FIG. 4 shows pulse response characteristic of an operational amplifier for explaining the present invention.

Referring to FIG. 4, when an input voltage 501 is applied to the operational amplifier without having delay in rise time and fall time, an output voltage 502 has response time 502a in rise time and response time 502b in fall time according to pulse response characteristic of the operational amplifier.

The LLC half-bridge power converter uses full wave frequency variation, and thus the efficiency thereof is improved. However, the threshold problem is generated in the secondary rectifier as the frequency increases because of delay, rise time and fall time of the primary switching elements. That is, the threshold problem that two rectifying (ON-OFF) pulses are not separated from each other but overlapped with each other may be generated due to delay in the rise time and fall time of the secondary rectifier (FET) because a full wave signal has no off time. This threshold problem corresponds to short-circuit state of the secondary rectifier, and thus the threshold problem may damage the power converter.

The present invention uses the characteristic of the operational amplifier, as shown in FIG. 4, to solve the threshold problem. Specifically, the threshold problem of the secondary rectifier is solved by generating off time at an appropriate set level using the characteristic that the output voltage of the operational amplifier has rise time and fall time. To achieve this, the present invention uses FETs as rectifying elements of the secondary rectifier. The FETs are controlled with a control pulse signal having off time to eliminate pulse overlapped periods and secondary short-circuit due to the rectifier.

The operation principle of the LLC half-bridge power converter for driving an LED according to the present invention will now be explained.

The LLC half-bridge power converter for driving an LED according to the present invention implements high-speed power switching through primary synchronizing with an input pulse signal applied to the primary side to improve the speed and efficiency of the secondary rectifier 300.

In the LLC half-bridge power converter for driving an LED according to the present invention, as shown in FIG. 5, the first transformer T1 of the output unit 100 and a second transformer T2 of the input pulse detector 410 of the rectifier controller 400 start to operate in phase with each other at the same time when a 50% duty cycle frequency pulse signal is input from a control IC (not shown). That is, when the voltage at a first terminal (#4) of the primary coil of the first transformer T1 is high, as shown in FIG. 5, the voltage at a first terminal (#10) of a first secondary coil of the first transformer T1 becomes high to turn on the first FET Q1.

Accordingly, current flows through the inductor L1 of the resonator 200 to charge the resonating condenser C5 through the primary coil of the third transformer T3. During this operation, the voltage at a first terminal (#3) of a second secondary coil of the third transformer T3 becomes high.

The aforementioned operation is repeated such that the voltages are changed between high and low levels according to the input pulse signal.

In the rectifier controller 400, the input pulse detector 410 receives the input pulse signal applied to the output unit 100 and detects the input pulse signal in phase with the first transformer T1. That is, the first transformer T1 and the second transformer T2 operate in phase with each other, and thus the voltages at the second terminals (#6) of the second secondary coils of the first and second transformers T1 and T2 become low and the voltages at the first terminals (#10) of the first secondary coils of the first and second transformers T1 and T2 become high when the voltages at the first terminals (#4) of the primary coils of the first and second transformers T1 and T2. The low signal is applied to an inverted input terminal (−) of an operational amplifier U2 of the delay unit 430 through a condenser C1 and a resistor R3. A voltage set by the delay time setting unit 420 is applied to a non-inverted input terminal (+) of the operational amplifier U2. Similarly, the high signal is applied to a non-inverted input terminal (+) of an operational amplifier U1 of the delay unit 430 through a condenser C2 and a resistor R1. A reference value set by the delay time setting unit 420 is applied to an inverted input terminal (−) of the operational amplifier U1.

The delay time setting unit 420 sets the reference value through voltage-dividing resistors to generate a rising edge and a falling edge at appropriate levels in consideration of the rise time and fall time in the waveform characteristic of FIG. 4. Accordingly, the delay unit 430 generates delayed pulse signals for pulse signals applied thereto.

When a low signal is output from the second terminal (#6) of the second secondary coils of the second transformer T2, the low signal is applied to the inverted input terminal (−) of the operational amplifier U2 and a high signal is applied to the non-inverted input terminal (+) of the operational amplifier U2, and thus the operational amplifier U2 outputs a high signal. Here, the waveform of the output signal has of the operational amplifier U2 has response time T that is the property of the operational amplifier, as shown in FIG. 4. That is, unchanged off time is generated even during frequency variation that is the principal purpose of the LLC half-bridge power converter of the present invention.

The positive DC voltage is removed from the high signal output from the operational amplifier U2 of the delay unit 430 using a condenser C4 of the rectifier control pulse generator 440 and only a pulse input to the operational amplifier U2 is applied to a first input terminal of an AND gate U4 through a resistor R12. Resistors R10 and R12 can adjust the voltage of the input pulse to increase/decrease delay time.

A high pulse at the first terminal (#10) of the first secondary coil of the second transformer T2 is input to a second input terminal of the AND gate U4 through a condenser C11. Accordingly, the AND gate U4 outputs a high signal having a pulse width reduced by delay of the delay unit 430, that is, a high signal having a pulse width reduced by response time.

The high signal output from the AND gate U4 of the rectifier control pulse generator 440 is applied to a first input terminal of an AND gate U6 of the rectifier on/off time controller 450 and the output pulse signal of the third transformer T3, which is input to the third FET Q3 of the secondary rectifier 300, is applied to a second input terminal of the AND gate U6.

The high pulse at the first terminal (#10) of the first secondary coil of the second transformer T2 is applied to the second input terminal of the AND gate U4 through the condenser C11, and a low pulse is decreased by response time according to the operational amplifier U2 of the delay unit 430, inverted and applied to the first input terminal of the AND gate U4. Accordingly, the AND gate U4 outputs a high pulse.

The high pulse output from the AND gate U4 is applied to the first input terminal of the AND gate U6 and the high pulse of the first terminal (#3) of the second secondary coil of the third transformer T3 is input to the second input terminal of the AND gate U6, and thus a high pulse is applied to a gate of the fourth FET Q4 through a buffer U8. That is, when the high pulse output from the first terminal (#3) of the second secondary coil of the third transformer T3 and the high pulse output from the AND gate U4 are subjected to an AND operation by the AND gate U6 to generate a high pulse, the third FET Q3 is turned off, and thus the high pulse turns on the fourth FET Q4. That is, the output of the AND gate U4 is input to the buffer U8 and the high signal output from the buffer U8 turns on the fourth FET Q4.

The ON state of the fourth FET Q4 can achieve a high-speed/high-efficiency/synchronous switching rectifier without generating short-circuit of rectifying elements even when the frequency is varied from a low level to a high level due to delay time generated in the response time of the operational amplifier U2.

Consequently, the overall efficiency of the power converter employing the aforementioned high-speed synchronous switching rectifier is improved while power loss is remarkably reduced, compared to a conventional power converter using a Schottky rectifier.

The following table shows comparison of the high-speed synchronous switching rectifier using FETs according to the present invention to a conventional Schottky rectifier.

| Power converter | DC output 12 V/10 A |
|---|---|
| Schottky | STPS 20H 100CT - Vf 0.64 V |
| | 0.64(Ve) × 10 A = 6.4 W |
| FET | IRFB 3207ZPBF - Rds(on) 4.1 mΩ |
| | (Rds 0.0041 × 10 A) × 10 = 0.041 W |

As represented by the table, the present invention can reduce power loss of 5.9 W.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A primary drive synchronous high-speed switching rectifier circuit for an LLC half-bridge power converter for driving an LED, which comprises an output unit 100 receiving a 50% duty cycle pulse signal according to frequency control of a controller and generating pulse signals (having positive voltage periods and negative voltage periods) through a first transformer T1 and first and second switching FETs Q1 and Q2, a resonator 200 LLC-resonating the pulse signals of the output unit 100 according to an inductor L1, a primary coil of a third transformer T3 and a resonating condenser C5, and a secondary rectifier 300 rectifying pulse signals output from two secondary coils of the third transformer T3 of the resonator 200 through rectifying elements, smoothening the pulse signals and outputting DC power to a load,
wherein third and fourth FETs Q3 and Q4 are used as the rectifying elements of the secondary rectifier 300 to full-wave-rectify the pulse signals, and the LLC half-bridge power converter further comprises a rectifier controller 400 that is configured to delay an input pulse by delay time set in consideration of element delay, rise time and fall time and generate a control pulse signal having off time between pulses according to alternate combination of a delayed pulse and the input pulse to control the third and fourth FETs Q3 and Q4 of the secondary rectifier 300.

2. The primary drive synchronous high-speed switching rectifier circuit for an LLC half-bridge power converter for driving an LED according to claim 1, wherein the rectifier controller 400 comprises:
an input pulse detector 410 receiving the 50% duty cycle pulse signal through a primary coil and detecting the pulse signal through two secondary coils in phase with the first transformer T1;
a delay unit 430 comparing the pulse signal detected by the input pulse detector 410 with a reference signal of a delay time setting unit 420 and delaying rise time and fall time of the pulse signal;
a rectifier control pulse generator 440 alternately performing an AND operation on a pulse delayed by the delay unit 430 and negative and positive pulses detected by the input pulse detector 410 to generate a rectifier control pulse signal having off time between pulses; and
a rectifier on/off time controller 450 performing an AND operation on a first rectifier pulse input to the fourth rectifying FET Q4 of the secondary rectifier 300 and a second rectifier pulse input to the third rectifying FET Q3 of the secondary rectifier 300, buffering the AND operation resultant signals and alternately applying the buffered signals as gate control signals of the third and fourth rectifying FETs Q3 and Q4 to control on/off time of the rectifier pulse signal generated by the rectifier control pulse generator 440.
